(19) United States
(12) Patent Application Publication
(10) Pub. No.: US 2006/0113927 A1
(43) Pub. Date: Jun. 1, 2006

(54) Multiple dimmer lighting system

(76) Inventors: Montgomery Clifford Bondy, Gibsons (CA); Allen Bruce Hepworth, Port Moody (CA); Brent J. McKee, Gibsons (CA); Richard J. Bentley, Port Moody (CA)

Correspondence Address: Paul D. Gornall;Registered Patent & TM Agent, 1820 -- 355 Burrard St., Vancouver, BC, V6C 2G8, CA

(21) Appl. No.: 10/999,917

(22) Filed: Dec. 1, 2004

(51) Int. Cl. H05B 37/02

(52) U.S. Cl. 315/307

(57) ABSTRACT

A system of lighting in which a multitude of secondary line extra-low voltage lights each have an individual dimmer control with voltage compensating circuitry. This enables pre-setting of individual brightness for each light in the multitude. The individual lights have substantially spherical housings that allow for partial burial at different angles of illumination. The system is especially suited for garden lighting.

### FIELD OF THE INVENTION

This invention relates to outdoor lighting, where variation in placement and brightness of individual lights may provide striing contrasts of illumination of plants or buildings within a garden or other area.

### SUMMARY OF THE INVENTION

A system of lighting in which a multitude of secondary line extra-low voltage lights each have an individual dimmer control enables setting of individual brightness for each light in the plurality. Each individual dimmer control can be pre-set during insallation or adjusted afterward. The entire system can be switched on or off with a manual switch, timer switch, or photocell switch on the primary line voltage side of an approved transformer for the system. “Line voltage” is defined as voltage in the range of 30-750 Volts. Household electrical voltage of approximately 110 Volts is an example of line voltage. “Extra-low voltage” is defined as voltage of less than 30 Volts. Garden lights and study lamps are often run at 12 or 24 volts and are an example of extra-low voltage lines. The secondary line extra-low voltage lights with their respective individual dimmer controls are powered from the extra-low voltage secondary side of the transformer, preferably in the range of 10 to 24 Volts.

The multiple dimmer lighting system adjusts the brightness and power drawn by individual lamps via a configuration of secondary extra-low voltage lines. The extra-low voltage lamps thus have their light output adjusted individually. A printed circuit board which contains the control circuitry is mounted inside each lamp unit. After adjusting each lamp for brightness, the entire system can be turned on and off with a single switch. The system allows the use of extra-low voltage lamp units and extra-low voltage lines to connect the lamps in a configuration of AC or DC circuits preferably in the range of 10-24 volts, with light bulbs or like lighting units preferably being rated in the range of 12 to 40 Watts.

Such extra-low voltage lines are suitable for installation by home owners and amateur electricians as garden lighting. The lines can be buried without special conduits or building permits in many areas, preserving safety for pets, children and others who might later dig in the area in which the system is installed.

The dimmer control circuit compensates for voltage drop input and gives substantially the pre-selected light output, despite variations in secondary side output from the transformer or voltage drop due to secondary line length for various individual secondary power supply lines in the configuration. The individual lamp brightness is controlled by a switching dimmer circuit which varies the duty cycle of the power. This affects the lamp on time and hence varies the light output. To minimize lamp brightness changes with minor voltage variations, the supply voltage is sensed through divider resisters with feedback to an adjustment subcircuit. The voltage at the junction of the two resisters is fed to the integrated circuit to vary the duty cycle inversely to the supply voltage, thereby reducing the duty cycle as the voltage increases to maintain the lamp brightness about a constant level.

In a preferred embodiment, each unit lamp is contained in a housing that is substantially spherical and watertight sealed, suitable for embedding in a garden or beneath a shrub or tree, with its light aperture uncovered and oriented in a selected direction. When buried the housing is secure and stable in its orientation and protected from collision or vandalism.

The system switch can be an ordinary electrical wall-mounted switch inside or outside a house or building adjacent to or integral with an approved transformer. The system switch is on the primary voltage side of the transformer with the configuration of individual lamps connected to the secondary side of the transformer. Optionally, the system switch can be part of a remote control module implementing one of two methods. Radio, comprising a portable electronic radio frequency electronic remote control transmitter that transmits signals to control units in the housing of individual lights could be used, but it would be expensive. Alternatively and less costly, data can be sent down the power cables, using a remote control unit that would talk to a master receiver which would then send the signal down the power lines. Whether radio or data down the power cables is used, each lamp has its own ID and so although the signal would be received by all the lamp units, only the one with the correct ID would respond to the command.

As a further option, the system can be programmable such that the extra-low voltage lamp units can be turned on or off in accordance with a predetermined order, to perform a light show. Several modes can be stored, for example, a bright mode for a party, a dimmer mode when users of the ground are unlikely, and an emergency or alarm mode.

The individual lights are preferably supplied with soft-start electronics so that the individual lamps' brightness is increased gradually after turning on the system until each individual lamp reaches its pre-set brightness level set by its dimmer circuit. The soft-start is part of the control integrated circuit and minimizes current surges and so helps extend the life of the individual lamps. The integrated circuit used is for power supply circuits where current surges can be damaging. Soft start occurs very quickly in the matter of a fraction of a second and may be barely noticed by an observer when the lamps are turned on. A longer, more noticeable soft start for aesthetic purposes could optionally be programmed into the system and could be done irrespective of remote control.

The invention thus comprises a system of lighting in which a primary line voltage switch turns on or off a plurality of secondary extra-low voltage lines and lights each having individual dimmer controls that enable setting of different individual brightness levels.

The dimmer controls each have a voltage variation compensating circuit that maintains a pre-selected brightness level for its light despite supply line voltage variations to the transformer or extra-low voltage variations in the transformer's output.

An excellent embodiment would be to have such a system of multiple individually dimmed lights, in which:

a) a plurality of individual dimmer controls can be accessed after installation for adjustment of pre-set dimming;

b) a soft start module controls the multitude of lights upon turning on the system such that the lights gradually brighten to a pre-set level;

c) a plurality of lights are each encased in a substantially spherical housing suited for tilting in a substantially spherical mounting place at various selected orientations;

d) a plurality of lights are each encased in a weather-proof housing suited for partial burial in a garden;

e) extra-low voltage insulated electrical supply lines are used to connect a plurality of lights within the system, suited for installation by property owners who are not electricians;

f) a plurality of lights use extra-low voltage, long-life bulbs;

This system of lights that are buried but shining upwards to illuminate trees, shrubs, and overhanging can be complemented by having some of the individually dimmable lights equipped with housings that each have a ledge and a rim surrounding a lens for the light. The ledge and rim are used to support and hold the cylindrical walls of a column supporting a mushroom cap shade that captures light energy shining up from the light and reflects it downward.

### BRIEF DESCRIPTION OF THE DRAWINGS

FIG. 1 is a block diagram showing a system of garden lights using the invention.

FIG. 2 is a schematic diagram showing the electronics of an individual garden light of the system of FIG. 1.

FIG. 3 is a top view of an individual garden light of the system of FIG. 1.

FIG. 4 is a cross-sectional side view of the garden light of FIG. 3.

FIG. 5 is an exploded cross-sectional side view of the garden light of FIG. 3.

FIG. 6 is a side view showing a mushroom cap fitting into the garden light of FIG. 4.

FIG. 7 is a perspective view showing the system of FIG. 1 in operation.

### DETAILED DESCRIPTION

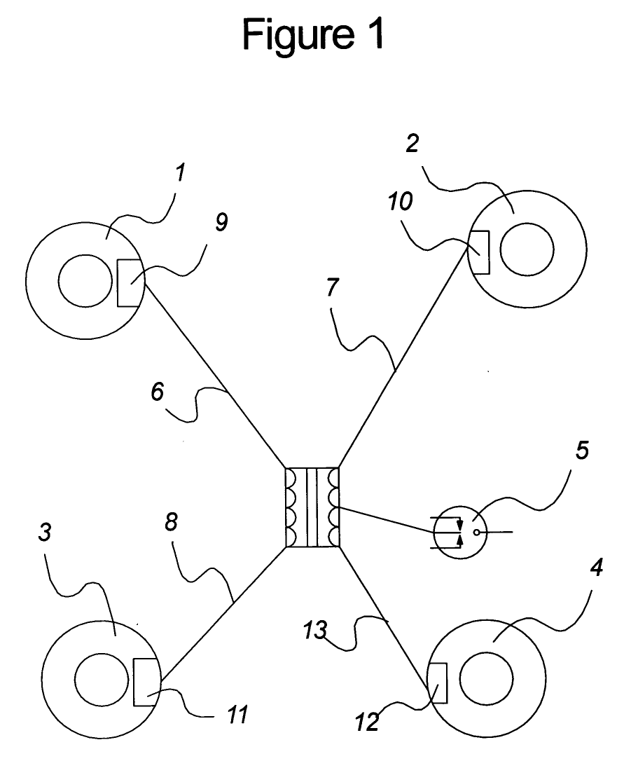

Referring to FIG. 1, the configuration consists of a first individual lamp 1, a second individual lamp 2, a third individual lamp 3, a fourth individual lamp 4, connected to a central primary line voltage control switch 5, by extra-low voltage lines 6, 7, 8. Each individual lamp 1-4 has its own dimmer circuit 9, 10, 11, and 12 respectively.

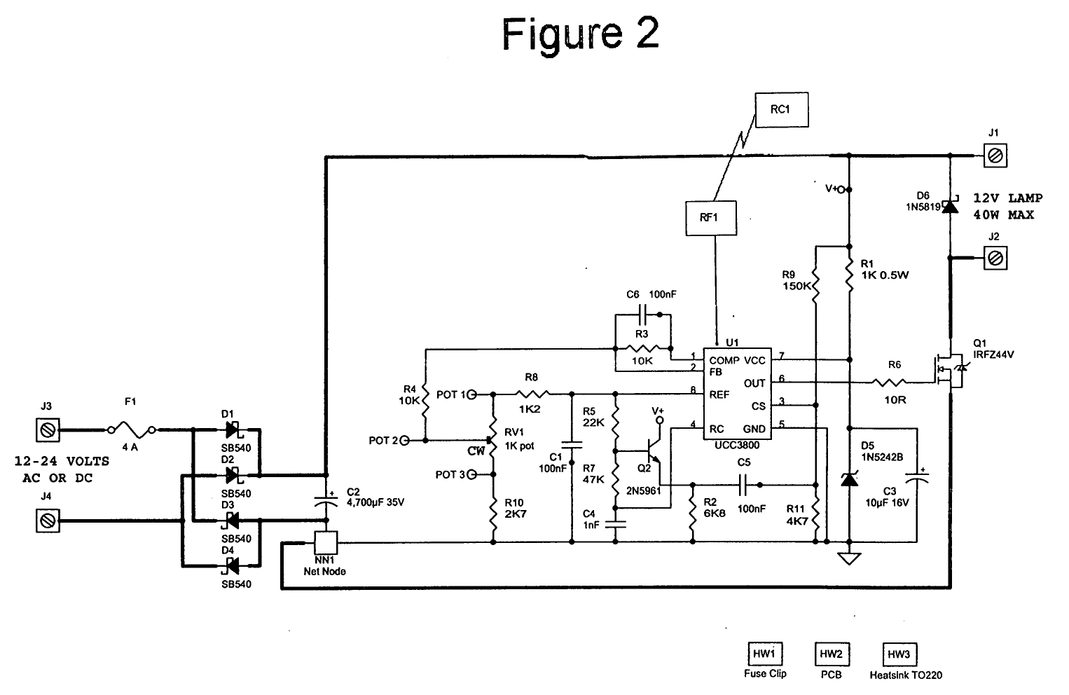

Referring to FIG. 2, the lamp brightness is controlled by a switching circuit in integrated circuit (IC) U1 which controls the soft start and varies the duty cycle of the power through Q1. The dimming level is set with screw adjuster pot RV1 which is rated 1K 20% 250 mW. This affects the lamp on time and hence the light output. To minimize lamp brightness changes with minor Voltage flow variations, the supply Voltage is sensed through the divider comprising R9 and R11.

Further electrical components complete the required circuits as shown in FIG. 2. C1, C5 and C6 are 100 nF monocap 50 V 20%; C2 is 4,700 uF Electrolytic 35V 20%; C3 is 10 uF electrolytic 16 V. Diodes D1-D4 are 5 amps, 40 V; D5 is 12V 5% 500 mW; D6 is 1 Amp, 40 V. R1 is 1K 5% 500 mW. R2-R11 are all 5% 250 mW; with values R2-6K8, R3 and R4-10K, R5-22K, R6-10R, R7-47K, R8-1K2, R9-150K, R10-2K7, R11-4K7. Fuse F1 is a fast 4 amp fuse, mounted in fuse clip HW1 on the dimmer control board 20, which comprises a printed circuit board HW2. HW3 is a heat sink to dissipate excess heat during operation to allow the components to function without degradation due to overheating. Q1 is an FET rated at 60V 55A and Q2 is a general purpose transistor 60 V 100 mA A current mode controller at U1 has a 100% duty cycle and is rated to operate in the range of 0- to 70 degrees C. A microcontroller is used to decode the remote control commands, checks the message ID and decides if the command is for this particular lamp unit. If the command is for another lamp unit, it is ignored. Commands for the lamp control are interpreted by the microcontroller and the appropriate output signal produced. The microcontroller circuitry at P1 can be set to instruct the controller U1 to perform a “soft” start, whereby the lights gradually increase in output until the desired, pre-set brightness of the lights in the system is achieved. The radio frequency receiver module RF1 is connected to the programmable logic integrated circuit P1 to enable a remote control transmitter RC1 to send commands to the dimmer control board 20.

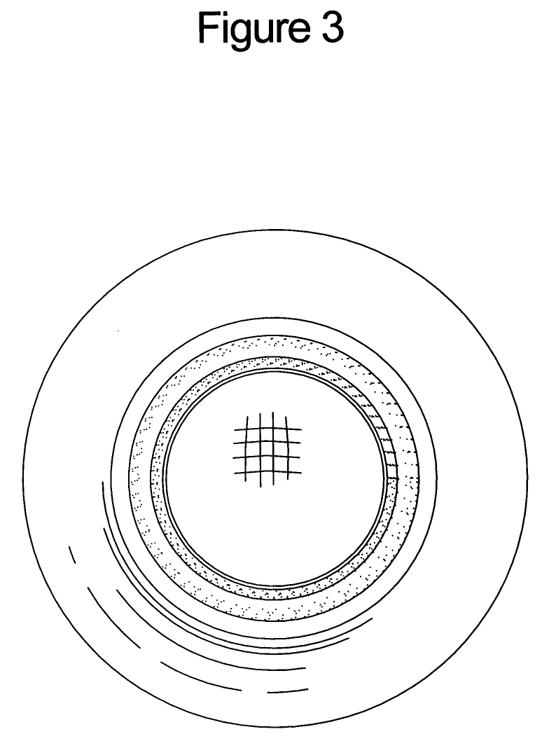

Referring to FIG. 3, the lamp has a substantially spherical housing 21, which is waterproof, suitable for burying such that only a top portion 22 adjacent to the lens cover 23 is exposed to shine on the target objects to be illuminated. The lens rim seal 24 keeps rain and dust from entering the lamp.

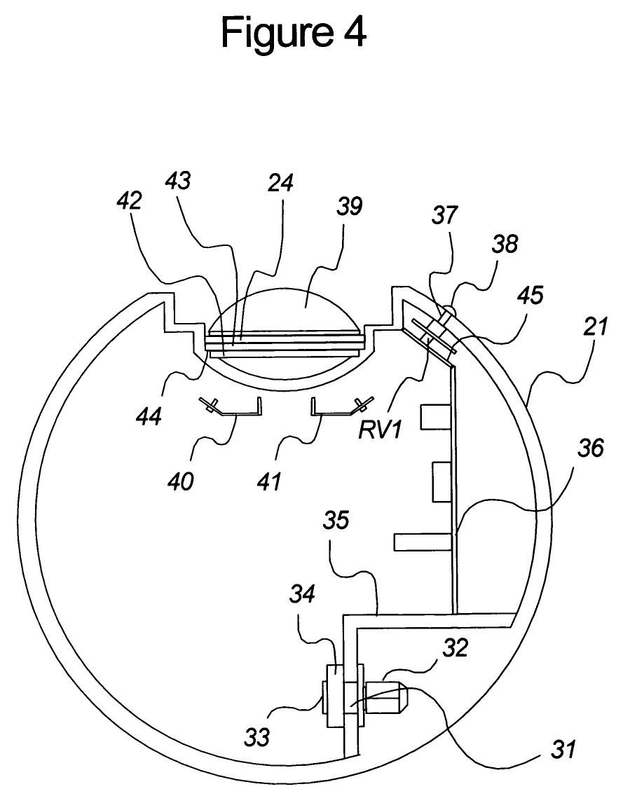

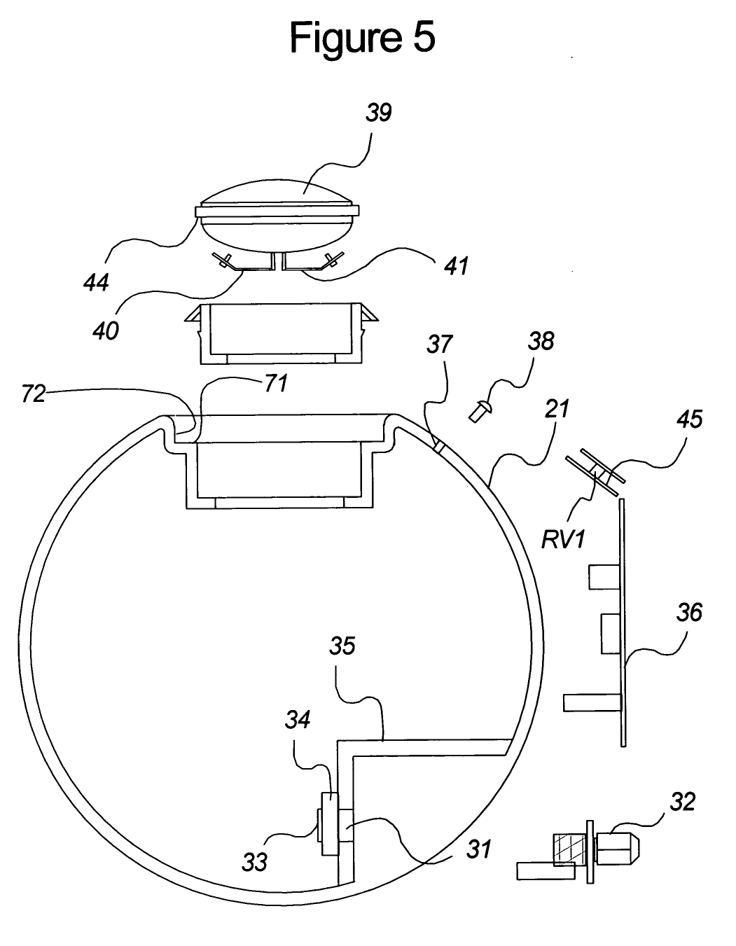

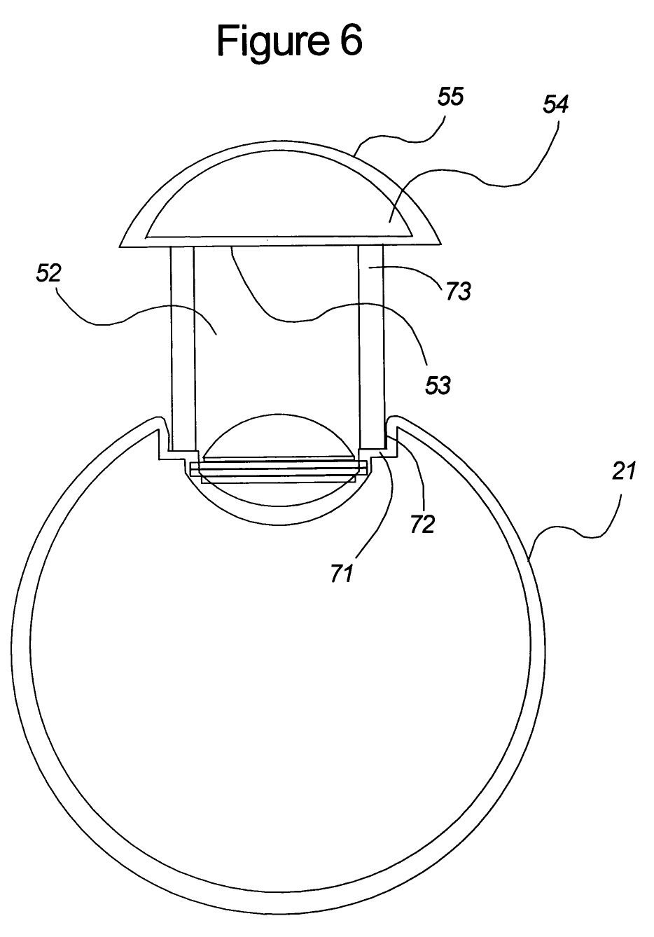

Referring to FIGS. 4 and 5, the housing 21 has a wire inlet 31, a wire inlet grommet 32, adapted to seal around an electrical supply wire and match the waterproof functionality of the housing 21, a wire inlet bolt 33, and a complementary nut 34. The wire inlet bolt 33 also serves to hold the bottom flange 35 of the dimmer control board 36. The dimmer's screw adjuster pot RV1 is set on an upper side flange 36 to enable to be positioned behind adjuster aperture 37. A dimmer screw adjuster plug 38 fits into the aperture 37 to seal against rain and dirt. A sealed beam light source 39, with electrical contacts 40 and 41 fits within the sealed beam cradle 42. The cradle is held in position in the housing 21 by means of compression flange 43. The lens rim seal 24 can be made of resilient material of a close-fitting tolerance pressed into position on the lens seal rim ledge 44. The housing 21 has an optional shade support ledge 71 and shade holding rim 72, suited to hold a shade wall 73. Thus in place of a flush lens seal, a mushroom shaped shade and reflector can be fitted onto the housing 21 as shown in FIG. 6. The mushroom shade and reflector 51 has a hollow column 52 up which the light from the lamp travels. Slots in the column near its top allow the light to then be reflected down from the underside 53 of the mushroom-shaped cap 54. The top of the mushroom-shaped cap 55 acts as a roof or umbrella to deflect rain, wind, dust, and snow from falling on the lamp.

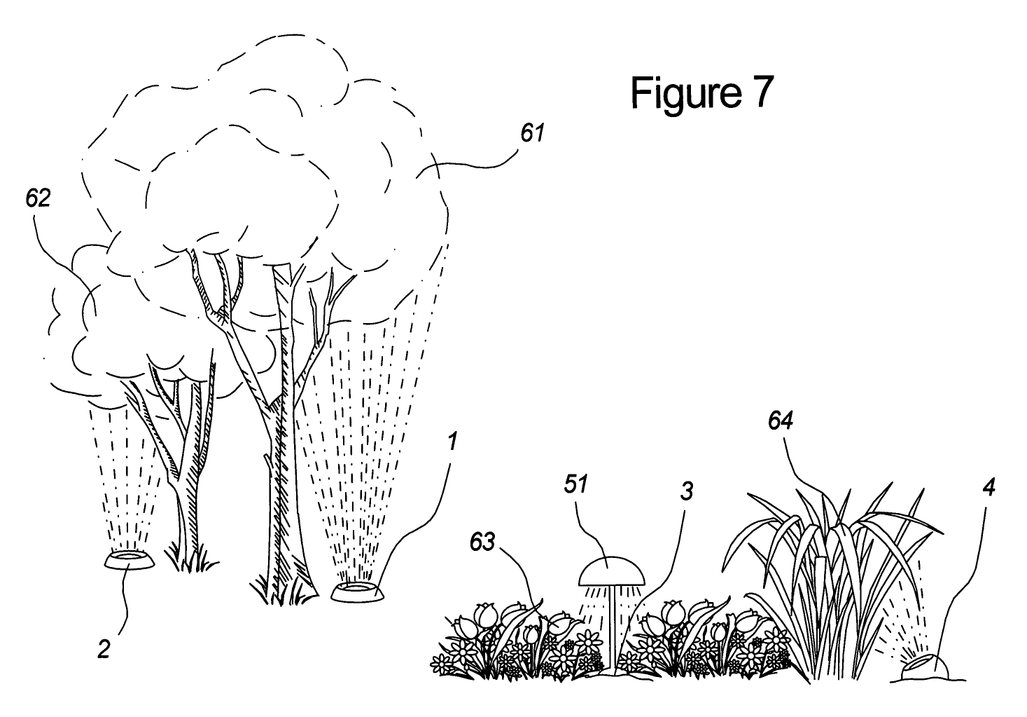

Referring to FIG. 7, the individual lamps 1, 2, 3 and 4 are pre-set at different levels of brightness. Lamp 1 is set at maximal brightness to illuminate a tall tree 61. Lamp 2 is set at a medium level to illuminate a shorter tree 62. Lamp 3 is set at a moderate level to illuminate a flower bed 63 via a mushroom-shaped shade and reflector 51. Lamp 4 is shown buried at an angle to illuminate an adjacent upright plant 64.

The extra-low voltage lines from the transformer to the individual lights can be more than a hundred yards long yet provide a consistent pre-selected light level due to the dimmer voltage compensation circuit.

As an alternative to having a remote control transmit wirelessly to individual lamp units' receiving modules is to transmit control signals down the extra-low voltage lines, which can thus be used as signal lines as well as electrical power supply lines.

The within-described invention may be embodied in other specific forms and with additional options and accessories without departing from the spirit or essential characteristics thereof The presently disclosed embodiment is therefore to be considered in all respects as illustrative and not restrictive, the scope of the invention being indicated by the appended claims rather than by the foregoing description, and all changes which come within the meaning and range of equivalence of the claims are therefore intended to be embraced therein.

I claim:

1. A system of lighting comprising a plurality of secondary extra-low voltage line lights, each having an individual dimmer control to enable setting of different individual brightness levels for the respective lights in the plurality.

2. The system of lighting of claim 1, in which at least one individual dimmer control comprises a voltage variation compensating circuit that maintains a pre-selected brightness level for its light despite supply line voltage variations.

3. The system of lighting of claim 1, in which a plurality of individual dimmer controls can be accessed after installation for adjustment of pre-set dimming.

4. The system of lighting of claim 1, in which a soft start module controls the multitude of lights upon turning on the system such that the lights gradually brighten to a pre-set level.

5. The system of lighting of claim 1, in which each of a plurality of lights have an individual soft start module such that individual lights brighten gradually at different speeds to pre-set levels.

6. The system of lighting of claim 1, in which a line voltage switch on the primary side of a transformer turns on or off the system.

7. The system of lighting of claim 1, in which a remote control device provides on/off switching for the line voltage to the system and provides centralized dimming control by sending diming commands to individual extra-low voltage lights in the system.

8. The system of lighting of claim 1, in which the remote control device provides programmable switching on and off and dimming of a plurality of individual lights.

9. The system of lighting of claim 1, in which a plurality of lights are each encased in a substantially spherical housing suited for tilting in a substantially spherical mounting place at various selected orientations.

10. The system of lighting of claim 1, in which a plurality of lights are each encased in a weather-proof housing suited for partial burial in a garden.

11. The system of lighting of claim 1, in which extra-low voltage insulated electrical supply lines are used to connect a plurality of lights within the system, suited for installation by property owners who are not electricians.

12. The system of lighting of claim 1, in which a plurality of lights use extra-low voltage, long-life bulbs.

13. The system of lighting of claim 1, in which at least one light has a housing with a ledge and a rim surrounding a lens for each light in the plurality, to enable the housing to support and hold enable portion of a housing has a case has top tube and ledge to hold and support a light shade

14. The system of lighting of claim 1, in which at least one light has a mushroom cap shade that captures light energy shining up from the light and reflects it downward.

15. The system of lighting of claim 2, in which:
a) a plurality of individual dimmer controls can be accessed after installation for adjustment of pre-set dimming;
b) a soft start module controls the multitude of lights upon turning on the system such that the lights gradually brighten to a pre-set level;
c) a line voltage switch on the primary side of a transformer turns on or off the system.
d) a plurality of lights are each encased in a substantially spherical housing suited for tilting in a substantially spherical mounting place at various selected orientations;
e) a plurality of lights are each encased in a weather-proof housing suited for partial burial in a garden;
f) extra-low voltage insulated electrical supply lines are used to connect a plurality of lights within the system, suited for installation by property owners who are not electricians;
g) a plurality of lights use extra-low voltage, long-life bulbs;

16. The system of lighting of claim 15, in which at least one light has a housing with a ledge and a rim surrounding a lens for the light, to enable the housing to support and hold a mushroom cap shade that captures light energy shining up from the light and reflects it downward.
